(19) United States
(12) Patent Application Publication
(10) Pub. No.: US 2026/0018713 A1
(43) Pub. Date: Jan. 15, 2026

(54) Prismatic Battery Cell Housing with Low CO2 Footprint

(71) Applicants: Martin Christoph Lentz, Bonn (DE); Holger Aretz, Spessart (DE); Waldemar Krieger, Neuss (DE); Mathis Ruppert, Bonn (DE); Philipp Kramer, Erftstadt (DE)

(72) Inventors: Martin Christoph Lentz, Bonn (DE); Holger Aretz, Spessart (DE); Waldemar Krieger, Neuss (DE); Mathis Ruppert, Bonn (DE); Philipp Kramer, Erftstadt (DE)

(73) Assignee: Speira GmbH, Grevenbroich (DE)

(21) Appl. No.: 19/337,066

(22) Filed: Sep. 23, 2025

Related U.S. Application Data
(63) Continuation of application No. PCT/EP2024/058557, filed on Mar. 28, 2024.

(30) Foreign Application Priority Data
Apr. 3, 2023 (EP) 23166405.3

(51) Int. Cl. H01M 50/119; H01M 50/103

(52) U.S. Cl. CPC H01M 50/119; H01M 50/103

(57) ABSTRACT

The invention relates to a prismatic battery cell housing having an aluminium material as well as a method for manufacturing a prismatic battery cell housing as well as a use of an aluminium material for manufacturing a prismatic battery cell housing. The object of providing prismatic battery cell housings with a reduced CO₂ footprint, specifying a method for their manufacture and proposing the use of an aluminium material for the manufacture of prismatic battery cell housings is achieved for the prismatic battery cell housing by the fact that the prismatic battery cell housing has an aluminium material with a ratio of the amount of carbon dioxide emitted (CO2e) during the manufacture of the aluminium material in kg_{CO2e} per kg_{Al material} to yield strength R_{p0.2} of the aluminium material in MPa of CO₂ₑ/R_{p0.2}≤6.15 kg_{CO2e}/(MPa*kg_{Al material}).

### CROSS-REFERENCE TO RELATED PATENT APPLICATIONS

This patent application is a continuation of International Application No. PCT/EP2024/058557, filed on Mar. 28, 2024, which claims the benefit of priority to European Patent Application No. 23166405.3, filed Apr. 3, 2023, the entire teachings and disclosures of both applications are incorporated herein by reference thereto.

### FIELD OF THE INVENTION

The invention relates to a prismatic battery cell housing having an aluminium material as well as a method for manufacturing a prismatic battery cell housing as well as a use of an aluminium material for manufacturing a prismatic battery cell housing.

### BACKGROUND OF THE INVENTION

Battery cells may essentially be differentiated into primary cells, which can only be discharged once and cannot be recharged, and secondary cells, which are rechargeable. The necessary electrochemical processes that provide the functionality of the battery cell may be implemented with a wide variety of different materials in both primary and secondary cells. Examples of primary cells in this context are alkali-manganese cells, zinc-carbon cells, nickel oxyhydroxide cells or lithium/iron sulphide cells, to name just a few. Examples of secondary cells are lithium ion cells, sodium ion cells, nickel-cadmium cells, nickel/metal hydride cells or nickel-zinc cells, to name just a few.

For a number of years, lithium ion secondary cells have increasingly been used particularly in the fields of electromobility and consumer electronics, among other things because of their comparatively high gravimetric and volumetric energy densities. Like other types of battery cells, lithium-ion secondary cells have a battery cell housing. This forms the outer shape of the battery cell and encloses a cavity, which contains among other things the anode material, the cathode material and an electrolyte. A distinction may be made between various designs of a battery cell housing: cylindrical battery cell housings essentially have the shape of a cylinder. If the height of the cylinder is greater than the diameter, they are referred to as round cells, otherwise as button cells. Battery cell housings of prismatic design essentially have the shape of a prism, in particular a cuboid. Another variant is the pouch design, in which the battery cell housing essentially has the shape of a pocket or pouch.

Prismatic battery cell housings consist of a battery cell housing jacket, which has a substantially rectangular cross section and thus enables a simple and space-saving arrangement of battery cells. Prismatic battery cell housings also have a battery cell housing base and a battery cell housing lid with means for contacting the two electrical terminals of the battery cell. Newer prismatic cell designs allow the lateral contacting of the battery cell, wherein the cell housing shell in this case corresponds to a tube with a rectangular cross-section, which is closed at both ends with lids that also contain the terminals, i.e. the contact points. This design is mainly used if the prismatic cells have an elongated design, whereby the length of the cell can be around 1000 mm.

A battery cell housing arrangement is known for example from the US patent application US 2022/0102787 A1, which discloses a battery cell volume of more than 50% by using individual, elongated, prismatic battery cells. The way in which the individual, prismatic battery cell housings are manufactured is not disclosed.

The use of lithium-ion secondary cells for storing electrical energy is a key technology in combating global climate change, as it enables highly efficient and economical storage of electrical energy. At the same time, the production of lithium-ion secondary cells causes greenhouse gas emissions, which are quantified by means of CO₂ equivalents (CO₂ₑ). If greenhouse gas emissions or CO₂ emissions are referred to in the following, this always refers to their CO₂ equivalents (CO₂ₑ). According to information provided by a European battery manufacturer in 2021, around 10% of greenhouse gas emissions are caused solely by the provision of the mechanical components of a battery cell, in particular the battery cell housing. For example, prismatic battery cell housings are now manufactured from sheets of an aluminium alloy of type AA3003 in the state H14 with a yield strength R_{p0.2} of more than 125 MPa.

This type of aluminium alloy is based on the use of primary aluminium due to its composition. Primary aluminium is aluminium that is produced directly from the raw material bauxite or from the clay extracted from it. Since it is produced in aluminium mills, it is also known as mill aluminium. Taking into account the greenhouse gas emissions from primary metal consumed in Europe at 8.6 kg_{CO2e}/kg_{Al material} up to the manufacturing of the rolling ingot, between 3 and 4% of the greenhouse gas emissions from the manufacturing of a prismatic battery cell are attributable to the manufacturing of the battery cell housing for this primary aluminium-based aluminium material.

However, the plan is to reduce greenhouse gas emissions during the manufacturing of the battery cells by a factor of 10 from a current level of around 100 kg_{CO2e}/kWh to around 10 kg_{CO2e}/kWh. This could increase the share of greenhouse gas emissions of the battery cell housing per kWh to up to 30 to 40% of the greenhouse gas emissions of the entire battery cell per kWh, provided that the share of greenhouse gas emissions or the CO₂ equivalents of the battery cell housing are not reduced.

The report “ENVIRONMENTAL PROFILE REPORT, Life-Cycle Inventory Data for Aluminium Production and Transformation Processes in Europe, February 2018” (https://european-aluminium.eu/wp-content/uploads/2023/01/European-Aluminium_Environmental-PROFILE-REPORT-2018_full-version.pdf) shows which greenhouse gas emissions are quantified via CO₂ equivalents (CO₂ₑ) in kg_{CO2e}, in the production of aluminium and aluminium alloy products in Europe. The CO₂ equivalents were determined in the report according to the ISO 14040 and 14044 standards. The standards therefore provide a predefined method for determining CO₂ equivalents. Identical standards were used for the determination of CO₂ equivalents in other regions, for example for aluminium production in North America in the report “The Environmental Footprint of Semi-Fabricated Aluminium Products in North America, A Life cycle Assessment Report”, the Aluminium Association (https://www.aluminium.org/sites/default/files/2022-01/2022_Semi-Fab_LCA_Report.pdf).

Michael Zotter's thesis entitled “Life-Cycle Analysis of Lightweight Construction Concepts for Automotive Engineering” from the Graz University of Technology in April 2014 is also based on the international standards ISO 14040 and ISO 14044 for determining CO₂ equivalents. In the professional world, CO₂ equivalents are therefore determined according to the two above-mentioned standards.

All CO₂ equivalents in kg_{CO2e} mentioned below therefore refer in particular to CO₂ equivalents in kg_{CO2e} determined in accordance with ISO 14040 and ISO 14044.

### SUMMARY OF THE INVENTION

Based on this, the object of the present invention is to provide prismatic battery cell housings with a reduced CO₂ footprint, to specify a method for manufacturing them and to propose an aluminium material for use in the manufacture of prismatic battery cell housings.

According to the invention, the above-mentioned object for a prismatic battery cell housing to have an aluminium material forming the battery cell housing is achieved by the aluminium material having a ratio of a mass of carbon dioxide (CO₂ₑ) emitted during the manufacture of the aluminium material in kg_{CO2e} per kg_{Al material} to the yield strength R_{p0.2} of the aluminium material of
CO₂ₑ/R_{p0.2} of a maximum of 6.15% kg_{CO2e}/(MPa*kg_{Al material}),
preferably CO₂ₑ/R_{p0.2} of a maximum of 5% kg_{CO2e}/(MPa*kg_{Al material}),
particularly preferably CO₂ₑ/R_{p0.2} of a maximum of 4% kg_{CO2e}/(MPa*kg_{Al material}) or of a maximum of 2% kgco₂ₑ/(MPa*kg_{Al material}), whereby the yield strength R_{p0.2} according to DIN EN ISO 6892-1 is measured at room temperature.

It has been shown that with an aluminium material with a ratio of CO₂ₑ/R_{p0.2} of a maximum of 6.15% kg_{CO2e}/(MPa*kg_{Al material}), a reduction in greenhouse gas emissions in the manufacture of battery cell housings of about 10% can be achieved compared to the primary metal-based reference material AA3003 in the state H14 with a yield strength R_{p0.2} of more than 125 MPa, produced with greenhouse gas emissions of 8.6 kg_{CO2e}/kg Al material.

The ratio CO₂ₑ/R_{p0.2} can be used to indicate the saving in greenhouse gas emissions in the form of CO₂ of the aluminium material, regardless of the exact aluminium alloy classification. The ratio therefore indicates a material property of the aluminium material. The claimed upper limit therefore indicates a reduction in greenhouse gas emissions for the manufacture of a prismatic battery cell housing, taking into account form factors of the battery cell housing and the reference material AA3003 in the state H14 with a yield strength of 125 MPa. This takes into account both the specifications of the previous standard material for the prismatic battery cell housing and the possibilities of different manufacturing processes for the aluminium material to avoid CO₂ emissions.

The starting point for the following considerations is that the prismatic battery cell housing meets at least the strength requirements with the previous standard material made of an aluminium alloy AA3003 in the state H14 with R_{p0.2} of 125 MPa.

FIG. 1 shows a schematic view of a prismatic battery cell housing with a length 1, a width a and a depth b. The wall thickness of the aluminium material is designated s. For the purposes of simplification, the following calculations assume that the prismatic battery cell housing consists of a battery cell housing jacket with a rectangular cross-section and two lids, whereby the same thickness is assumed for the lids. This represents a simplification, in particular in the case of a deep drawn or impact extruded prismatic battery cell housing, since the thickness of the battery cell housing lid and the thickness of the battery cell housing base present due to the forming process can differ. The bringing together of two lids of equal thickness is used to simplify the calculations, as there is no significant impact on the calculated change in greenhouse gas emissions. In addition, a density ρ_{Alu}=2.7 g/cm³ is assumed for all aluminium materials.

In order to derive the necessary wall thickness ratio of the aluminium material, the internal pressure loading scenario practically relevant for battery cell housings is considered. For simplification, the battery cell housing is assumed to be a closed and thin-walled prismatic cylinder. By theoretically cutting through the planes of symmetry of the prismatic tube, the respective stresses acting there can be calculated as follows using the equilibrium of forces:

$${σ}_{b} = \frac{p}{2} \cdot ( \frac{b}{ξ \cdot s} - 2 ) ; {σ}_{a} = \frac{p}{2} \cdot ( \frac{b}{s} - 2 ) ; {σ}_{l} \approx \frac{p}{2} \cdot ( \frac{b}{s \cdot ( 1 + ξ )} ) \qquad ( 1 )$$

with
σ_{b}: Stress in the surface in the plane of symmetry perpendicular to dimension b,
σₐ: Stress in the surface in the plane of symmetry perpendicular to dimension a,
σₗ: Stress in the surface in the plane of symmetry perpendicular to dimension 1,
ξ: Geometry factor, defined as ξ [symbol] b/a,
ρ: Active internal pressure.

Depending on the ratio b/a, the maximum stress σₘₐₓ of the three possible stresses {σₐ; σ_{b}; σₗ} is either σₐ or σ_{b}. In the present situation, σₘᵢₙ the minimum stress is σₘᵢₙ=−p. The reference stress according to Tresca states:

$${σ}_{V , T r e s c a} = {σ}_{max} - {σ}_{min} = max \{ {σ}_{a} , {σ}_{b} \} + p \qquad ( 2 )$$

Since the internal pressure here is negligible compared to the other active stresses, one can write in simplification:

$${σ}_{V , Tresca} \approx max \{ {σ}_{a} , {σ}_{b} \} \qquad ( 3 )$$

The tube is now R_{p0.2} designed to prevent the start of flow or yield strength:

$${σ}_{V , Tresca} = {R}_{p 0.2} \approx max \{ {σ}_{a} , {σ}_{b} \} = max \{ \frac{p}{2} . ( \frac{b}{ξ \cdot s} - 2 ) , \frac{p}{2} . ( \frac{b}{s} - 2 ) \} \qquad ( 4 )$$

This relationship can be described as follows:

$${R}_{p 0.2} = \frac{p}{2} \cdot max \{ ( \frac{b}{ξ \cdot s} - 2 ) , ( \frac{b}{s} - 2 ) \} = \frac{p}{2} \cdot [ max \{ ( \frac{b}{ξ \cdot s} ) , ( \frac{b}{s} ) \} - 2 ] \qquad ( 5 )$$

The following geometric assumption is now introduced:

$$max \{ ( \frac{b}{ξ \cdot s} ) , ( \frac{b}{s} ) \} ≫ 2 \qquad ( 6 )$$

This gives the approximation:

$$max \{ ( \frac{b}{ξ \cdot s} ) , ( \frac{b}{s} ) \} - 2 \approx max \{ ( \frac{b}{ξ \cdot s} ) , ( \frac{b}{s} ) \} = \frac{b}{s} \cdot max \{ \frac{1}{ξ} 1 \} \qquad ( 7 )$$

This results in a simplified relationship:

$${R}_{p 0.2} \approx \frac{p \cdot b}{2 s} \cdot max \{ \frac{1}{ξ} 1 \} \qquad ( 8 )$$

Converted according to the internal pressure, this ρ results in:

$$p \approx {R}_{p 0.2} \cdot \frac{2 s}{b \cdot max \{ \frac{1}{ξ} 1 \}} \qquad ( 9 )$$

Two tubes made of different materials are now examined, which have different wall thicknesses s, but otherwise identical dimensions a, b and 1. At the same internal pressure, you then get

$${R}_{p 0.2 , Alu} \cdot {s}_{Alu} = {R}_{p 0.2 , 3003 Std} \cdot {s}_{3003 Std} \qquad ( 10 )$$

Based on this, the wall thickness of the aluminium material is calculated in relation to the reference material of an aluminium alloy AA3003 in the state H14 with a yield strength of 125 MPa:

$${s}_{Alu} = \frac{{R}_{p 0.2 , 3003 Std}}{{R}_{p 0.2 , Alu}} \cdot {s}_{3 \; 003 Std} \qquad ( 11 )$$

with
S_{Alu}: Wall thickness of the substituting aluminium material,
S_{3003Std}: Wall thickness of the reference material AA3003 in the state H14,
R_{p0.2,Alu}: yield strength R_{p0.2} of the substituting aluminium material,
R_{p0.2,3003Std}: Yield strength R_{p0.2} of the reference material with R_{p0.2,3003Std}=125 MPa.

For the lid of the prismatic battery cell housing, the internal pressure stability requirement results in a different relationship. Starting from the approximation:

$$\frac{{R}_{p 0.2}}{p} \approx \frac{{σ}_{max}}{p} \qquad ( 12 )$$

where p is the internal pressure in the prismatic battery cell housing and σₘₐₓ the maximum stress of the lid material according to Tresca, the proportionality of the ratio of tension and pressure at a wall thickness of s for a plate with a uniform pressure load acting normally on the surface (e.g. Dubbel, “Pocket Book for Mechanical Engineering”, 19th edition, Springer Verlag 1997: Chapter C, “Strength gauge”) results in

$$\frac{{R}_{p 0.2}}{p} ∝ \frac{1}{{s}^{2}} . \qquad ( 13 )$$

When comparing two materials with identical geometry, (13) results in

$${( {s}^{2} \cdot \frac{{R}_{p 0.2}}{p} )}_{A l u} = {( {s}^{2} \cdot \frac{{R}_{p 0.2}}{p} )}_{3003 S f d} \qquad ( 14 )$$

Based on the reference material of an aluminium alloy of type AA3003 in the state H14 with the given wall thickness of the lid, the following follows if the identical internal pressure stability is achieved for the wall thickness of the new aluminium material:

$${s}_{Alu , D} = {s}_{3003 Std , D} * {( \frac{{R}_{p 0.2 , 3003 Std}}{{R}_{p 0.2 , Alu}} )}^{\frac{1}{2}} \qquad ( 15 )$$

The mass w of the battery cell housing jacket of the reference material is approximated from the cross-sectional area multiplied by the length 1 and the density

$${w}_{3003 Std} = {ρ}_{3003 Std} * V = {ρ}_{Alu} * 1 * 2 * {s}_{3003 Std} * ( a + b ) \qquad ( 16 )$$

The mass w_{Alu} of the battery cell housing jacket can be determined by applying the wall thickness ratio from (11) as:

$${w}_{Alu} = {ρ}_{Alu} * {V}_{Alu} == {ρ}_{Alu} * 1 * 2 * \frac{{R}_{p 0.2 , 3003 Std}}{{R}_{p 0.2 , Alu}} * {s}_{3003 Std} * ( a + b ) . \qquad ( 17 )$$

In order to determine the approximate mass of the lid, the lid surface is multiplied by the wall thickness and density

$${w}_{3003 Std , D} = a * b * {s}_{30 \; 03 Std , D} * {ρ}_{Alu} \qquad ( 18 )$$

The mass of the lid according to the invention is produced in the same way by means of the same relationship using the wall thickness ratio. Consequently:

$${w}_{Alu , D} = a * b * {( \frac{{R}_{p 0.2 , 3003 Std}}{{R}_{p 0.2 , Alu}} )}^{0.5} * {s}_{3003 Std , D} * {ρ}_{Alu} \qquad ( 19 )$$

The total mass is the sum of the mass of the battery cell housing jacket and the two lids

$${w}_{30 \; 03 Std , total} = {ρ}_{Alu} ( 1 * 2 * {s}_{3003 Std} * ( a + b ) + 2 * a * b * {s}_{30 \; 03 Std} ) \qquad ( 20 )$$

$${w}_{Alu , total} = {ρ}_{Alu} * ( L * 2 * \frac{{R}_{p 0.2 , 3003 Std}}{{R}_{{p 0.2 , Alu}^{}}} \cdot {s}_{3003 Std} * ( a + b ) + 2 * a * b * {( \frac{{R}_{p 0.2 , 3003 Std}}{{R}_{{p 0 , 2 , Alu}^{}}} )}^{0.5} * {s}_{3003 Std , D} ) \qquad ( 21 )$$

The percentage change in greenhouse gas emissions for the prismatic battery cell housing is determined using the products of the respective masses in kg of the battery cell housing and the respective mass of the emitted greenhouse gases as CO₂ equivalents in kg_{CO2e} per kg of the respective material:

$$\frac{{w}_{Alu , total} * C {O}_{2 e , Alu} - {w}_{3003 Std , total} * C {O}_{2 e , 3003 Std}}{{w}_{3003 Std , total} * C {O}_{2 e , 3003 Std}} \qquad ( 22 )$$

$$= \frac{C {O}_{2 e , Alu} * ( 1 * 2 * \frac{{R}_{p 0.2 , 3003 Std}}{{R}_{{p 0.2 , Alu}^{}}} \cdot {s}_{3003 Std} * ( a + b ) + 2 * a * b * {( \frac{{R}_{p 0.2 , 3003 Std}}{{R}_{{p 0.2 , Alu}^{}}} )}^{0.5} * {s}_{3003 Std , D} )}{( C {O}_{2 e , 3003 Std} ( 1 * 2 * {s}_{3003 Std} * ( a + b ) + 2 * a * b * {s}_{3 \; 003 Std , Lid} )} - 1 \qquad ( 23 )$$

CO_{2e,Alu},CO_{2e,3003Std}: mass of greenhouse gases emitted expressed as CO₂ equivalents in kg_{CO2e}/kg _{alu or} 3003Std,
wherein the “Alu” index indicates the values for the respective aluminium material that saves greenhouse gas emissions.

For the aluminium material according to the invention with a ratio of CO₂ₑ/R_{p0.2} of a maximum of 6.15% kg_{CO2e}/(MPa*kg_{Al material}), for example, the format PHEV2+ of the prismatic battery cell housing with a length of 148 mm, a width of 91 mm and a depth of 26.5 mm, an initial thickness of the standard material AA3003 H14 of s_{30003 Std}=0.5 mm and an initial thickness of the lid of s 3003Std_{D}=1.5 mm results in a saving of more than 9% in CO₂ emissions. The savings can be made based on an increase in the yield strength, a reduction in the CO₂ emissions of the aluminium material used or a combination of these measures.

To achieve greater savings in CO₂ emissions, the selected aluminium material preferably has a ratio of CO₂ₑ/R_{p0.2} of a maximum of 5% kg_{CO2e}/(MPa*kg_{Al material}), particularly preferably a maximum of 4% kg_{CO2e}/(MPa*kg_{Al material}) or particularly preferably a maximum of 2% kg_{CO2e}/(MPa*kg_{Al material}). Based on the prismatic battery cell housings in PHEV2+ format provided with the above-mentioned wall thicknesses, there is a CO₂ emission saving of at least 20% at a maximum of 5% kg_{CO2e}/(MPa*kg_{Al material}), particularly preferably at least 32% at a maximum of 4% kg_{CO2e}/(MPa*kg_{Al material}) or particularly preferably at least 60% at a maximum of 2% kg_{CO2e}/(MPa*kg_{Al material}).

According to a first embodiment, the prismatic battery cell housing has a length (1) of a maximum of 1200 mm, preferably a maximum of 600 mm, particularly preferably a maximum of 300 mm, a width (a) of a maximum of 500 mm, preferably a maximum of 300 mm, particularly preferably a maximum of 200 mm and a depth (b) of a maximum of 90 mm, preferably a maximum of 60 mm, particularly preferably a maximum of 40 mm, wherein the battery cell housing optionally has a format HEV 1, HEV 2, PHEV 1 PHEV 2, BEV 1, BEV 2, BEV 3, BEV 4 in accordance with DIN 91252 2016-11, PHEV 2+ or a blade format.

Prismatic battery cell housings with the above-mentioned dimensions allow a compact arrangement of battery cell housings specific to the respective application and designed, for example, with a view to optimised heat dissipation. Preferred format types of the prismatic battery cell housings are the formats HEV1, HEV 2, PHEV1 PHEV 2, BEV 1, BEV 2, BEV 3, BEV 4 in accordance with DIN 91252 2016-11, but also the PHEV2+ format. All of the formats mentioned are used for battery-operated electric vehicles. The preferred PHEV2+ format has a length (1) of 148 mm, a width (a) of 125 mm and a depth (b) of 26.5 mm.

Further preferred are so-called prismatic battery cell housings in “blade format”, which allow direct use in a “cell-to-pack” design, whereby a battery cell module formation can be dispensed with. The preferred blade formats are characterised by a particularly large length (1) up to a maximum of 1200 mm, with a width (a) of a maximum of 300 mm, preferably 200 mm and a depth (b) of a maximum of 60 mm, preferably a maximum of 40 mm.

According to a further advantageous embodiment, the aluminium material is an aluminium wrought material. Aluminium wrought materials have the property of allowing high degrees of deformation as is necessary for the manufacture of prismatic battery cell housings. At the same time, they provide a very dense microstructure compared to cast aluminium materials, so the impermeability requirements of the prismatic battery cell housings can also be met.

A preferred heat-treatable aluminium wrought material is provided by the aluminium alloys of type AA6xxx. These can be extruded into a battery cell housing jacket in the form of prismatic tubes, which can provide the battery cell housing with two battery cell lids. This enables an economical manufacturing process to be provided.

Naturally hard aluminium wrought materials can be manufactured with simpler manufacturing processes than heat-treatable aluminium wrought materials, which can also generally be associated with lower CO₂ emissions, since, for example, high annealing steps can be avoided at the final thickness, as required for the solution annealing of heat-treatable alloys. With regard to thermal joining methods such as those used for welding prismatic battery cells, the naturally hard aluminium materials have a significantly lower tendency to decrease in strength and generally possess good corrosion resistance. The naturally hard aluminium materials optionally consist of an aluminium alloy of type AA1xxx, AA3xxx, AA5xxx or AA8xxx, the manufacturing processes of which are well known.

According to a further embodiment, lower greenhouse gas emissions are achieved provided that the battery cell housing is an aluminium alloy of type AA1050, AA1100, AA1200, AA3003, AA3004, AA3104, AA3005, AA3105, AA5005, AA5052, AA5454, AA5754, AA5182, AA5083, AA5086, AA8006, AA8008, AA8010, AA8011, AA8111, AA8021, AA8026, AA8050 or AA8079. Different production processes for the prismatic battery cell housing can be followed with the alloy types specified.

For example, the lower-alloyed aluminium alloy of the 1xxx alloy class is particularly suitable for extrusion processes, while aluminium alloys of types AA3003, AA3004, AA3104, AA3005 or AA3105 provide high degrees of forming in the manufacture of battery cell housings, for example from sheet metal cut-outs, but also provide good to very good welding properties. At the same time, the alloy types AA3004, AA3104, AA3005 or AA3105 are particularly recyclable and enable high proportions of recycled material.

The higher magnesium contents of the aluminium alloy types AA5005, AA5052, AA5454, AA5754, AA5182, AA5083 or AA5086 not only lead to excellent forming properties, but can also provide particularly high yield strengths, even in soft condition, so savings potentials in terms of greenhouse gas emissions can be utilised to the maximum thanks to lower wall thicknesses of the battery cell housing jacket. At the same time, the alloy types AA5052, AA,5454, AA5754, AA5182, AA5083 and AA5086 allow a high proportion of recycled material due to their chemical composition.

Alloy types AA8006, AA8008, AA8010, AA8011, AA8111, AA8021, AA8026, AA8050 and AA8079 not only enable higher recycling contents to be achieved thanks to their broader alloy windows compared to AA1xxx alloys, but also enable higher strengths. Due to the high permissible iron content, the alloys are particularly suitable for absorbing ferrous scrap.

The aluminium material in the battery cell housing preferably has a yield strength R_{p0.2} of at least 100 MPa, preferably at least 150 MPa, particularly preferably at least 175 MPa. Soft aluminium materials with yield strengths R_{p0.2} of less than 100 MPa often allow particularly high degrees of forming, but require higher wall thicknesses compared to the standard material AA3003 in the H14 state to provide sufficient strength. From a yield strength of 100 MPa and above, savings in CO₂ emissions can be achieved in relation to an identical battery cell format with a constant gravimetric energy density, mainly through savings in aluminium production, in particular through the use of external scrap and through the use of primary aluminium, which contains a high proportion of primary aluminium produced with renewable energies. With higher yield strengths of at least 150 MPa or at least 175 MPa, these savings are supplemented by additional material savings, which also have a positive impact on the reduction of greenhouse gas emissions.

The CO₂ emissions for primary aluminium used in the European Union (EU) are on average 8.6 kg_{CO2e}/kg_{Al}. If the aluminium material of the battery cell housing therefore preferably consists at least partially of a primary aluminium, the amount of CO₂ emitted per kg of aluminium material of the battery cell housing during the manufacture of this is a maximum of 6.7 kg_{CL2e}/kg_{Al}, preferably a maximum of 5 kg_{CO2e}/kg_{Al}, particularly preferably a maximum of 4 kg_{CO2e}/kg_{Al}, significant reductions in greenhouse gas emissions can also be achieved via the primary metal portion. Corresponding values for greenhouse gas emissions per kg of primary aluminium can be achieved by using renewable energy during manufacturing, in particular renewable electricity. A maximum of 4 kg_{CO2e}/kg_{Al} is achieved if the primary metal is produced entirely by using renewable energies, i.e. CO₂-neutral energies.

If, during the manufacture of the aluminium material of the battery cell housing, the greenhouse gas emissions per kg aluminium material of the battery cell housing amount to a maximum of 4 kg_{CO2e}/kg_{Al material}, preferably a maximum of 3 kg_{CO2e}/kg_{Al material}, particularly preferably a maximum of 2 kg_{CO2e}/kg_{Al material}, the ratio CO₂ₑ/R_{p0.2} according to the invention of a maximum of 6.15% kg_{CO2e}/(MPa*kg_{Al material}) can also be achieved with less hard aluminium materials, such as AA1xxx alloys. The proportion of external scrap and/or post-consumer scrap must be selected accordingly for this purpose.

According to a further teaching of the present invention, the above-mentioned object of providing a method for manufacturing a battery cell housing according to the invention is achieved in that the method comprises forming the aluminium material and preferably comprises deep drawing, wall-ironing, impact extrusion, extrusion or roll forming of the aluminium material. Deep drawing, wall-ironing, impact extrusion and extrusion are forming processes that enable economical manufacturing of the battery cell housings. At the same time, however, the manufacturing processes also set limits for the use of specific aluminium alloys. For example, softer aluminium wrought alloys such as AA1050 are preferred for impact extrusion or extrusion processes.

A method for manufacturing prismatic battery cell housings which particularly efficiently avoids CO₂ emissions can be provided in that the aluminium material of the battery cell housing is manufactured at least 30%, preferably at least 60% and particularly preferably 100% from primary aluminium produced with CO₂-neutral energy. By using 100% primary aluminium produced with CO₂-neutral energy, the CO₂ emissions for the correspondingly produced primary aluminium are reduced from 8.6 to 4 kg_{CO2e}/kg_{Al material} compared to the average primary metal consumed in the EU, which corresponds to a reduction of more than 50%.

According to a further embodiment, the aluminium material is manufactured at least 40%, preferably at least 70% from external scrap and/or post-consumer scrap, wherein internal scrap can optionally also be used to manufacture the aluminium material.

In addition to the manufacturing of the aluminium material, due to the manufacturing and further processing that has already taken place the internal scrap has an additional 0.3 kg_{CO2e}/kg_{Al material} higher CO₂ emissions than, for example, the manufacturing of the primary metal. Nevertheless, taking these metal sources into account contributes to increasing the efficiency of manufacturing the prismatic battery cell housings, as material consumption is significantly reduced by remelting the internal scrap and waste is avoided. External scrap and/or post-consumer scrap contribute significantly to reducing the CO₂ emissions of the aluminium material, as they only generate 0.5 kg_{CO2e}/kg _{Al material}. It is therefore desirable for the proportion of this scrap to be as high as possible.

According to a further configuration, a slug is first manufactured from the aluminium material, the slug being extruded into a cup-shaped, prismatic battery cell housing blank. From the cup-shaped battery cell housing blank, the prismatic battery cell housing having a battery cell housing jacket and a battery cell housing bottom is finally formed by means of at least one further forming step, preferably by wall-ironing, wherein aluminium alloys of type AA1xxx, AA3xxx but also AA6xxx are preferably used for the aluminium material. A battery cell housing lid can also be subsequently manufactured via a sheet metal cut-out, for example in the form of a punched part, and the prismatic battery cell housing can be closed with this after its assembly.

In an alternative method for manufacturing the battery cell housing, an aluminium strip is first manufactured from the aluminium material by rolling, from which aluminium strip a prismatic battery cell housing having a battery cell housing jacket and a battery cell housing base is manufactured, for example directly from the aluminium strip or from sheet metal cut-outs from the aluminium strip, by means of deep drawing and wall-ironing processes, wherein an aluminium alloy of type AA1xxx, AA3xxx, AA5xxx or AA8xxx should preferably be used. The manufacturing steps of deep drawing or wall-ironing are tried-and-tested industrial process steps that can be carried out in a highly automated manner with low energy consumption, i.e. without complex annealing processes. This method is therefore also suitable for particularly efficient manufacturing of the prismatic battery cell housings.

Also starting from an aluminium strip, an aluminium strip can initially be manufactured from the aluminium material by rolling according to a further alternative embodiment. Using a roll-forming method, a roll-formed battery cell housing jacket, which has a prismatic cross-section at least in areas, is formed from the aluminium strip and the battery cell housing jacket is joined in the longitudinal direction, preferably in a positive-locking, frictional and/or material-bonded manner. The prismatic battery cell housing jacket is then cut to length and joined with a battery cell housing bottom made from a sheet metal cut-out made from an aluminium strip made from the same or a different aluminium material in a positive-locking, frictional and/or material-bonded manner, wherein an aluminium alloy of type AA1xxx, AA3xxx, AA5xxx or AA8xxx is preferably used. Roll forming, longitudinal seam joining and cutting and joining of battery cell housing lids are also industrially proven methods that lead to advantageous properties of the battery cell housing using the above-mentioned aluminium alloys. At the same time, the above-mentioned methods are also to be regarded as particularly energy efficient, so CO₂ emissions continue to be dominated by the aluminium alloy manufacturing process.

According to a further alternative embodiment, a tube with a prismatic cross-section is extruded from the aluminium material, which is optionally cut to length and is joined in a positive-locking, frictional and/or material-bonded manner after at least one optional processing step to provide the finally formed battery cell housing jacket with a battery cell housing base from a sheet metal cut-out made from an aluminium strip made from the same or another aluminium material, wherein an aluminium alloy of type AA1xxx, AA3xxx, AA5xxx, AA6xxx or AA8xxx is preferably used.

In order to provide a finished prismatic battery cell housing, according to a further embodiment, the cup-shaped battery cell housings manufactured with the previously described methods are closed with a battery cell housing lid made of a sheet metal cut-out made of an aluminium material after the cell assembly by arranging the electrodes and the active material in the cup-shaped battery cell housing. Here too, positive-locking, frictional and/or material-bonded joining methods should preferably be used.

Finally, the object shown above is achieved by using an aluminium material to manufacture a prismatic battery cell housing, wherein the aluminium material has a ratio of the amount of greenhouse gases emitted during the manufacture of the aluminium material expressed as CO₂ equivalents of carbon dioxide (CO₂ₑ) in kg_{CO2e} per kg_{Al material} to the yield strength R_{p0.2} of the aluminium material in MPa of
CO₂ₑ/R_{p0.2}≤6.15% kg_{CO2e}/(MPa*kg_{Al material}),
preferably CO₂ₑ/R_{p0.2}≤5% kg_{CO2e}/(MPa*kg_{Al material}),
particularly preferably CO₂ₑ/R_{p0.2}≤4% kg_{CO2e}/(MPa*kg_{Al material}) or
CO₂ₑ/R_{p0.2}≤2% kg_{CO2e}/(MPa*kg_{Al material}).

The use of the aluminium material according to the invention ensures a significant saving in greenhouse gas emissions compared to the current standard material of a primary aluminium-based aluminium alloy AA3003 in the state H14 at 125 MPa.

### BRIEF DESCRIPTION OF THE DRAWINGS

The invention is described in greater detail below using exemplary embodiments in connection with the drawing. The drawing

FIG. 1 shows a schematic representation of a battery cell with a prismatic battery cell housing,

FIG. 2 is a flowchart of a method for manufacturing a prismatic battery cell housing by impact extrusion according to a first embodiment,

FIG. 3 is a flowchart of a method for manufacturing a prismatic battery cell housing by deep drawing and wall-ironing a cut-out of an aluminium strip according to a second embodiment,

FIG. 4 is a flow chart for manufacturing a prismatic battery cell housing by roll forming and longitudinal seam joining according to a third embodiment and

FIG. 5 is a flow chart for manufacturing a prismatic battery cell housing by extruding a prismatic tube according to a fourth embodiment.

### DETAILED DESCRIPTION

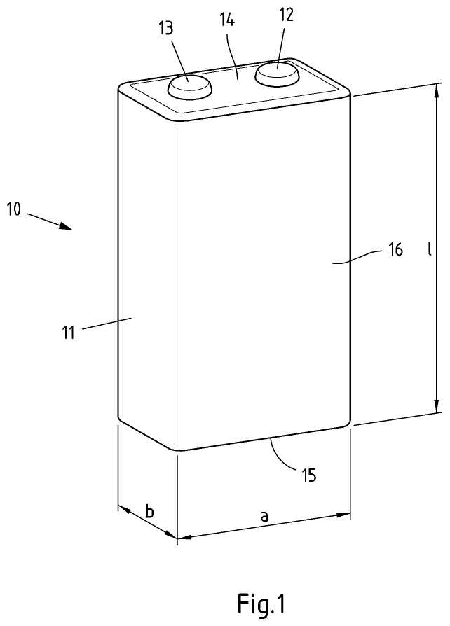

First FIG. 1 shows, in a schematic representation, a battery cell 10 with prismatic battery cell housing 11. The battery cell 10 has, in addition to the battery cell housing 11, an anode terminal 12 and a cathode terminal 13. As already described above, the prismatic battery cell housing 11 has two battery cell housing lids 14 and 15 as well as a battery cell housing jacket 16.

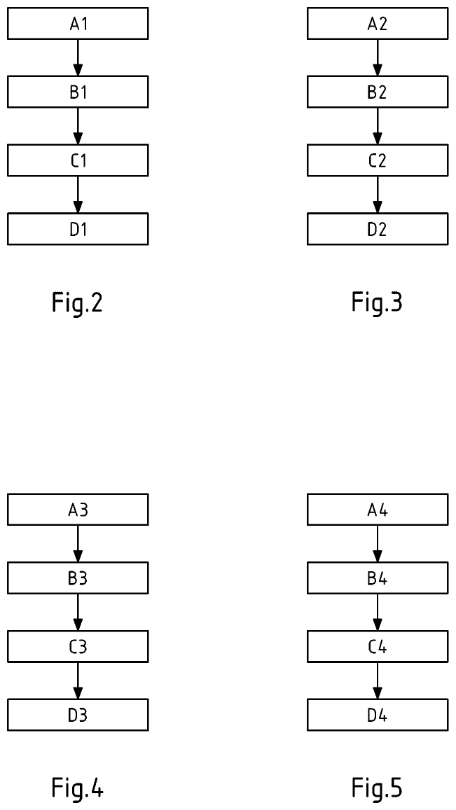

FIG. 2 is a schematic view of a manufacturing method of an embodiment.

According to step A1, a slug is first manufactured from an aluminium material. The manufacture of a slug can for example be carried out by sawing a rod having a corresponding diameter. Alternatively, sluges can be manufactured from rolling or casting belt manufacturing, wherein the sluges are punched from the rolling or casting belt and then surface treated and optionally annealed. The slug is then inserted into an impact extrusion tool and impact extruded into a prismatic battery cell housing blank by an impact extrusion press in accordance with step B1. This is reworked in step C1 by at least one manufacturing step, for example cutting or stretching to the prismatic battery cell housing 11 with battery cell housing base 15 and battery cell housing jacket 16, and is available for cell assembly. In step D1, the cell is assembled with the battery cell housing lid also joined to the battery cell housing jacket 16 in a positive-locking, frictional and/or material-bonded manner.

The starting point for the embodiments illustrated in FIG. 3 and FIG. 4 is an aluminium strip, which is provided in step A2 or A3 respectively.

For example, the aluminium strip can be manufactured by the following steps:
Casting a rolling ingot from an aluminium alloy,
Optionally homogenising the rolling ingot,
Hot rolling the rolling ingot to form a hot-rolled strip,
Cold rolling the hot rolled strip with optional intermediate annealing.

After cold rolling, the strips may be in the states H12, H14, H16, H18 or H19. However, the cold rolling can optionally be followed by a heat treatment of the strip in the form of solution annealing, preferably in the form of reverse annealing. After reverse annealing, the yield strength values R_{p0.2} are barely reduced. However, the possible degrees of forming are significantly improved in the H24 state, for example.

Alternatively, the aluminium strip in step A2 or A3 can also be provided by continuous casting, optionally using twin-roll casters or twin-belt casters, which enable large production capacities. After the casting belt has been cast, for example, cold rolling takes place at the final thickness of the aluminium strip.

According to FIG. 3, in step B2, a prismatic battery cell housing having a battery cell housing jacket and a battery cell housing base is manufactured from the rolled aluminium strip by deep drawing and wall-ironing processes, wherein an aluminium alloy of type AA1xxx, AA3xxx, AA5xxx or AA8xxx is preferably used. The deep drawing and wall-ironing processes preferably take place on blanks of the aluminium strip, but can also be carried out in subsequent composite tools on the aluminium strip. In step C2, a further forming step is optionally carried out to achieve the final geometry of the prismatic battery cell housing 11 including the battery cell housing base 15 and battery cell housing jacket 16. In step D2, the cell is assembled, which includes joining the battery cell housing lid 14 to the battery cell housing jacket 16 by means of positive-locking, frictional and/or material-bonded joining.

According to FIG. 4, a roll-formed battery cell housing jacket, which has a prismatic cross-section at least in areas, is formed from the rolled aluminium strip by means of a roll-forming method in step B3. The battery cell housing jacket is then joined in the longitudinal direction, preferably in a positive-locking, frictional and/or material-bonded manner and cut to length in step B3, wherein the battery cell housing jacket can optionally also be joined with longitudinal seam only after cutting. In step C3, a battery cell housing base that has been cut to size made from a sheet metal cut-out made from an aluminium strip made from the same or a different aluminium material is joined to the battery cell housing jacket 16 in a positive-locking, frictional and/or material-bonded manner, wherein an aluminium alloy of type AA1xxx, AA3xxx, AA5xxx or AA8xxx is preferably used for the battery cell housing jacket 16 or the battery cell housing lids 14 and 15. In step D3, the cell is assembled, which among other things includes closing the battery cell housing jacket 16 with two battery cell housing lids 14 by means if positive-locking, frictional and/or material-bonded joining.

Further conceivable manufacturing processes are direct and indirect extrusion, as well as pipe drawing processes and combinations of these processes, which allow for the manufacture of a tubular body that can serve as a battery cell housing jacket. A flowchart of a process of this type is shown in FIG. 5. For this purpose, a tube with a prismatic cross-section is extruded from the aluminium material in step A4, which is cut to length in the optional step B4 and, if necessary, converted into an end-formed battery cell housing jacket by at least one optional processing step. In step C4, the battery cell housing jacket is joined to a battery cell housing base made from a sheet metal cut-out made from an aluminium strip made from the same or a different aluminium material in a positive-locking, frictional and/or material-bonded manner, wherein an aluminium alloy of type AA1xxx, AA3xxx, AA6xxx or AA8xxx is preferably used. Then, in step D4, the cell can be assembled and the battery cell closed with another battery cell housing lid.

The prismatic battery cell housings 11, which can be manufactured with the preceding processes, were examined with regard to the possibilities for saving greenhouse gas emissions. The following assumptions were made. CO₂ emissions are mainly dominated by the provision of aluminium alloys, in particular by the use of primary aluminium. For sheet metal production, as a rule only 0.4 kg_{CO2e}/kg_{Al material} is generated. On the global average, the production of primary aluminium emits 16 kg_{CO2e}/kg _{Al material}. Primary aluminium consumed in the European Union, on the other hand, has an emission rate of only 8.6 kg_{CO2e}/kg_{Al material}. In the following, it is assumed for the calculation that internal scrap from primary metal with a CO₂ equivalent of 8.6 kg_{CO2e}/kg_{Al material} is used and an average emission of 0.3 kg_{CO2e}/kg_{Al material} is used for its processing, so this is evaluated as having an emission rate of 8.9 kg_{CO2e}/kg_{Al material}. External scrap and post-consumer scrap are reported with 0.5 kg_{CO2e}/kg_{Al material}. If primary aluminium is produced using CO₂-emission-neutral energies alone, this results in 4 kg_{CO2e}/kg _{Al material} (see International Aluminium Association: https://international-aluminium.org/statistics/greenhouse-gas-emissions-intensity-primary-aluminium/)

In Tables 1 and 2, the relationships shown in equation (23) with respect to embodiments according to the invention and comparative examples have now been examined. Table 1 contains embodiments according to the invention while Table 2 contains comparative examples.

The first three columns of both tables indicate the alloy designation, the temper state and the yield strength tested. This is the minimum yield strength according to DIN EN 485-2 of the aluminium alloy in the respective temper state. There are then 5 columns which indicate the proportions of the respective primary metal and/or the internal and external scrap of the aluminium materials tested. With a heading of CO₂ₑ, the 6th column is the CO₂ footprint of the aluminium material including 0.4 kg_{CO2e}/kg_{Al material} for the manufacture of the battery cell housing and from this value the ratio to the yield strength is indicated in the 7th column.

The greenhouse gas savings specified below are determined on the basis of equation (23), taking into account the battery format PHEV2+ used as an example, further taking into account the above-mentioned dimensions and wall thicknesses of the reference material AA3003 in the state H14 with a yield strength R_{p0.2} of 125 MPa and current greenhouse gas emissions of 8.6 kg_{CO2e}e/kgAl material for the manufacture of the primary aluminium up to the rolling ingot.

It was found that all aluminium materials tested from the aluminium alloys of type AA1xxx, AA3xxx, AA5xxx and AA8xxx at a ratio of CO₂ₑ/R_{p0.2} of a maximum of 6.15% kg_{CO2e}/(MPa*kg_{Al material}) can provide a reduction in greenhouse gas emissions compared to the current reference material from an aluminium alloy of type AA3003 in the state H14 with a yield strength R_{p0.2} of 125 MPa manufactured from primary aluminium with 8.6 kg_{CO2e}/kg_{Al material}, provided that certain specifications are made for the yield strength R_{p0.2} as well as for the origin of the primary aluminium and scrap portions. The yield strength R_{p0.2} for the reference material made of an AA3003 aluminium alloy in the state H14 was assumed to be the minimum value of 125 MPa achievable in accordance with DIN EN 485-2. As already stated above, a maximum of 6.15% kg_{CO2e}/(MPa*kg_{Al material}) results in a saving of at least 9% when using the battery cell format PHEV2+ for the prismatic battery cell housing with a length of 148 mm (1), a width (a) of 91 mm and a depth (b) of 26.5 mm, an initial thickness of the standard material AA3003 in the state H14 of s_{30003 Std}=0.5 mm and an initial thickness of the lid of s 3003Std, _{D}=1.5 mm.

Embodiments 1 to 12 according to the invention have a ratio of CO₂ₑ/R_{p0.2} of a maximum of 6.15% to more than 5% kg_{CO2e}/(MPa*kg_{Al material}), such that a saving of at least 9% in greenhouse gas emissions in kg_{CO2e}/kg_{Al material} is achieved taking into account an HVEP2+ geometry. It can be seen that when choosing an aluminium material with a lower yield strength R_{p0.2} that a saving in greenhouse gas emissions can only be achieved by changing the primary metal source to, for example, 100% primary metal, which is manufactured with renewable energy. This is demonstrated by embodiment No. 1. However, an identical effect can also be achieved by adding external scrap, see embodiment No. 2.

Embodiments 13 to 23 achieve even higher savings in greenhouse gas emissions with a ratio of CO₂ₑ/R_{p0.2} of a maximum of 5% kg_{CO2e}/(MPa*kg_{Al material}). This saving is at least 20% in the above-mentioned embodiments. In the case of an unchanged primary metal source (EU mix), this can only be achieved with a significant increase in the yield strength R_{p0.2} to, for example, 185 MPa in embodiment No. 18. However, if the primary source is changed, soft aluminium materials with R_{p0.2} up to a maximum of 100 MPa can still achieve this saving, as for example in embodiment 25.

An even higher saving in CO₂ emissions is achieved in embodiments 24 to 36 with a ratio of CO₂ₑ/R_{p0.2} of a maximum of 4% kg_{CO2e}/(MPa*kg_{Al material}). This is at least 35%. It becomes clear that the saving can only be achieved by high-strength aluminium materials without changing the primary metal source or using external scrap, as shown by embodiment 32.

With a ratio of CO₂ₑ/R_{p0.2} of a maximum of 2% kg_{CO2e}/(MPa*kg_{Al material}), embodiments 37 to 49 show the maximum savings in greenhouse gas emissions. These are at least 65% and, as shown in the embodiments, can be achieved with lower or equal yield strengths R_{p0.2} compared to the reference material AA3003 in the state H14 essentially only using high proportions of external scrap, as shown in embodiment 48, for example. Due to the high CO₂ footprint of internal scrap, these can only be used in combination with higher proportions of solid materials and in combination with higher proportions of external scrap to achieve such high savings in greenhouse gas emissions.

As the comparative examples in Table 2 show, high yield strengths R_{p0.2} or the use of proportions of primary metal produced with purely renewable energy sources cannot individually achieve the saving in greenhouse gas emissions.

The ratio of CO₂ₑ/R_{p0.2} with a maximum of 6.15% kgCO₂ₑ/(MPa*kg_{Al material}) is therefore an important property of the aluminium material for providing prismatic battery cell housings with a reduced CO₂ footprint.

TABLE 1
Embodiments according to the invention

| | | | Ratio of | Ratio of | | | | | | |
|---|---|---|---|---|---|---|---|---|---|---|
| | | | primary | internal | Ratio of external | | | | | |
| | | | metal in [%] | scrap | scrap [%] | | | | | |
| | | | manufactured | [%] | Energy | | | | | |
| | | | from | Energy | mix | | | CO₂ₑ | CO₂ₑ/ | |
| AA | Temper | R_{p0.2} | Renewable | mix Ø | Ø | | | [kg_{CO2e}/ | R_{p0.2} | |
| alloy | state | (MPa) | energy | EU | global | | | kg_{Al material}] | [%] | No. |
| 1050 | H14 | 85 | 100 | | | | | 4.4 | 5.18 | 1 |
| 1050 | H14 | 85 | | 30 | | | 70 | 3.33 | 3.92 | 2 |
| 1050 | H18 | 120 | 60 | | | 40 | | 6.4 | 5.30 | 3 |
| 3003 | H18 | 170 | | 100 | | | | 9.0 | 5.29 | 4 |
| 3005 | H18 | 200 | | | 30 | 70 | | 11.4 | 5.72 | 5 |
| 3105 | H18 | 180 | | 100 | | | | 9.0 | 5.00 | 6 |
| 5005 | H24 | 110 | | 60 | | | 40 | 5.8 | 5.24 | 7 |
| 5005 | H24 | 110 | | | 30 | | 70 | 5.6 | 5.05 | 8 |
| 5052 | H24 | 150 | | 60 | | 40 | | 9.1 | 6.08 | 9 |
| 5182 | O | 110 | | 60 | | | 40 | 5.8 | 5.24 | 10 |
| 8011 | H14 | 110 | 60 | | | 40 | | 6.4 | 5.78 | 11 |
| 8011 | H14 | 110 | | 60 | | | 40 | 5.8 | 5.24 | 12 |
| 8011 | H24 | 100 | | 60 | | | 40 | 5.8 | 5.76 | 13 |
| 1050 | H19 | 130 | | 60 | | | 40 | 5.8 | 4.43 | 14 |
| 3003 | H14 | 125 | | 60 | | | 40 | 5.8 | 4.61 | 15 |
| 3004 | H18 | 230 | | | 60 | | 40 | 10.2 | 4.43 | 16 |
| 3005 | H24 | 130 | 60 | | | 40 | | 6.4 | 4.89 | 17 |
| 3005 | H19 | 210 | | 30 | | 70 | | 9.2 | 4.39 | 18 |
| 5005 | H19 | 185 | | 100 | | | | 9.0 | 4.86 | 19 |
| 5754 | H14 | 190 | | 30 | | 70 | | 9.2 | 4.85 | 20 |
| 5182 | O | 110 | 100 | | | | | 4.4 | 4.00 | 21 |
| 5182 | H19 | 320 | | | 60 | 40 | | 13.6 | 4.24 | 22 |
| 5083 | H32 | 215 | | 100 | | | | 9.0 | 4.19 | 23 |
| 8011 | H16 | 130 | | 60 | | | 40 | 5.8 | 4.43 | 24 |
| 1050 | H14 | 85 | 60 | | | | 40 | 3.0 | 3.53 | 25 |
| 1050 | H14 | 85 | 30 | | | | 70 | 2.0 | 2.29 | 26 |
| 3003 | H18 | 170 | 60 | | | 40 | | 6.4 | 3.74 | 27 |
| 3003 | H18 | 170 | | | 30 | | 70 | 5.6 | 3.26 | 28 |
| 3005 | H19 | 210 | 30 | | | 70 | | 7.8 | 3.73 | 29 |
| 3105 | H24 | 120 | | 30 | | | 70 | 3.3 | 2.78 | 30 |
| 5005 | H18 | 165 | 60 | | | 40 | | 6.4 | 3.85 | 31 |
| 5005 | H18 | 165 | | 60 | | | 40 | 5.8 | 3.49 | 32 |
| 5052 | H18 | 240 | | 100 | | | | 9.0 | 3.75 | 33 |
| 5754 | H18 | 250 | | 100 | | | | 9.0 | 3.60 | 34 |
| 5182 | O | 110 | | 30 | | | 70 | 3.3 | 3.03 | 35 |
| 5083 | H14 | 280 | | 100 | | | | 9.0 | 3.21 | 36 |
| 8011 | H24 | 100 | | 30 | | | 70 | 3.3 | 3.33 | 37 |
| 1050 | H19 | 130 | 30 | | | | 70 | 2.0 | 1.50 | 38 |
| 3003 | H19 | 180 | 60 | | | | 40 | 3.0 | 1.67 | 39 |
| 3004 | H14 | 180 | 60 | | | | 40 | 3.0 | 1.67 | 40 |
| 3105 | H18 | 180 | 60 | | | | 40 | 3.0 | 1.67 | 41 |
| 3105 | H18 | 180 | | | 30 | | 70 | 3.3 | 1.85 | 42 |
| 5005 | H18 | 165 | 60 | | | | 40 | 3.0 | 1.82 | 43 |
| 5052 | H14 | 180 | 30 | | | | 70 | 2.0 | 1.08 | 44 |
| 5052 | H18 | 240 | 100 | | | | | 4.4 | 1.83 | 45 |
| 5754 | H14 | 190 | | 30 | | | 70 | 3.3 | 1.75 | 46 |
| 5182 | H19 | 320 | 30 | | | | 70 | 2.0 | 0.61 | 47 |
| 5182 | H19 | 320 | | 60 | | | 40 | 5.8 | 1.80 | 48 |
| 8011 | H14 | 110 | 30 | | | | 70 | 2.0 | 1.77 | 49 |
| 5182 | H19 | 320 | 60 | | | 40 | | 6.36 | 1.99 | 50 |

TABLE 2
Comparative examples

| | | | Ratio of | ratio of | | | | | | |
|---|---|---|---|---|---|---|---|---|---|---|
| | | | primary | internal | ratio of external | | | | | |
| | | | metal in [%] | scrap | scrap [%] | | | | | |
| | | | manufactured | [%] | Energy | | | | | |
| | | | from | energy | mix | | | CO₂ₑ | CO₂ₑ/ | |
| AA | Temper | R_{p0.2} | Renewable | mix Ø | Ø | | | [kg_{CO2e}/ | R_{p0.2} | |
| alloy | state | (MPa) | energy | EU | global | | | kg_{Al material}] | [%] | No. |
| 3003 | H14 | 125 | | 100 | | | | 9.0 | 7.20 | 1 |
| 3003 | H14 | 125 | | | 60 | | 40 | 10.2 | 8.16 | 2 |
| 1050 | H14 | 85 | | 100 | | | | 9.0 | 10.59 | 3 |
| 3004 | H14 | 180 | | | 100 | | | 16.4 | 9.11 | 4 |
| 3004 | H14 | 180 | | | 60 | 40 | | 13.6 | 7.53 | 5 |
| 3005 | H24 | 130 | | 100 | | | | 9.0 | 6.92 | 6 |
| 3105 | H14 | 130 | | 100 | | | | 9.0 | 6.92 | 7 |
| 5005 | H24 | 110 | 30 | | | 70 | | 7.8 | 7.12 | 8 |
| 5005 | H24 | 110 | | 100 | | | | 9.0 | 8.18 | 9 |
| 5005 | H18 | 165 | | | 30 | 70 | | 11.4 | 6.93 | 10 |
| 5052 | H24 | 150 | | | 30 | 70 | | 11.4 | 7.62 | 11 |
| 5052 | H24 | 150 | | | 60 | | 40 | 10.2 | 6.80 | 12 |
| 5052 | H18 | 240 | | | 100 | | | 16.4 | 6.83 | 13 |
| 5754 | H24 | 160 | | | 60 | | 40 | 10.2 | 6.38 | 14 |
| 5083 | O | 125 | | 100 | | | | 9.0 | 7.20 | 15 |
| 8011 | H16 | 130 | | 100 | | | | 9.0 | 6.92 | 16 |
| 8011 | H16 | 130 | | 60 | | 40 | | 9.1 | 7.02 | 17 |

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” ”.having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. Prismatic battery cell housing,
wherein
the prismatic battery cell housing has an aluminium material with a ratio of the amount of carbon dioxide (CO₂ₑ) emitted during the manufacture of the aluminium material in kg_{CO2e}kg_{CO2e} per kg_{Al material} to the yield strength R_{p0.2} of the aluminium material in MPa of
CO₂ₑ/R_{p0.2}≤6.15% kg_{CO2e}/(MPa*kg_{Al material}),
preferably CO₂ₑ/R_{p0.2}≤5% kg_{CO2e}/(MPa*kg_{Al material}),
particularly preferably CO₂ₑ/R_{p0.2}≤4% kg_{CO2e}/(MPa*kg_{Al material}) or
CO₂ₑ/R_{p0.2}≤2% kg_{CO2e}/(MPa*kg_{Al material}), wherein the yield strength R_{p0.2} is measured in accordance with DIN EN ISO 6892-1 at room temperature.

2. Battery cell housing according to claim 1,
wherein
the prismatic battery cell housing has a length of a maximum of 1200 mm, preferably a maximum of 600 mm, particularly preferably a maximum of 300 mm, a width of a maximum of 500 mm, preferably a maximum of 300 mm, particularly preferably a maximum of 200 mm and a depth (b) of a maximum of 90 mm, preferably a maximum of 60 mm, particularly preferably a maximum of 40 mm, and the battery cell housing optionally has a HEV 1, HEV 2, PHEV 1 PHEV 2, BEV 1 format, BEV 2, BEV 3, BEV 4 according to DIN 91252 2016-11, PHEV 2+ or a blade format.

3. Battery cell housing according to claim 1,
wherein
the aluminium material is an aluminium wrought material.

4. Battery cell housing according to claim 1,
wherein
the aluminium material is a naturally hard aluminium wrought material and optionally has an aluminium alloy of type AA1xxx, AA3xxx, AA5xxx or AA8xxx or is a heat-treatable aluminium wrought material and has an aluminium alloy of type AA6xxx.

5. Battery cell housing according to claim 1,
wherein
the battery cell housing (11) has an aluminium alloy of type AA1050, AA1100, AA1200, AA3003, AA3004, AA3104, AA3005, AA3105, AA5005, AA5052, AA5454, AA5754, AA5182, AA5083, AA5086, AA8006, AA8008, AA8010, AA8011, AA8111, AA8021, AA8026, AA8050 or AA8079.

6. Battery cell housing according to claim 1,
wherein
the aluminium material of the battery cell housing has a yield strength R_{p0.2} of more than 100 MPa, preferably 150 MPa, particularly preferably more than 175 MPa.

7. Battery cell housing according to claim 1,
wherein
the aluminium material consists at least partially of a primary aluminium, the amount of CO₂ emitted per kg aluminium material of the battery cell housing during the manufacture of which is a maximum of 6.7 kg_{CO2e}/kg_{Al material}, preferably a maximum of 5 kg_{CO2e}/kg_{Al material}, particularly preferably a maximum of 4 kg_{CO2e}/kg_{Al material}.

8. Battery cell housing according to claim 1,
wherein
2 emitted per kg aluminium material of the battery cell housing is a maximum of 4 kg_{CO2e}/kg_{Al material}, preferably a maximum of 3 kg_{CO2e}/kg_{Al material}, particularly preferably a maximum of 2 kg_{CO2e}/kg_{Al material}.

9. Method for manufacturing a prismatic battery cell housing according to claim 1,
wherein
the method comprises forming the aluminium material, preferably deep drawing, impact extrusion, extrusion or roll forming of the aluminium material.

10. Method according to claim 8,
wherein
the aluminium material is manufactured at least 30%, preferably at least 60% and particularly preferably 100% from primary aluminium produced with CO₂-neutral energy.

11. Method according to claim 8,
wherein
the aluminium material is manufactured from primary-based aluminium and at least 40%, preferably at least 70%, external scrap and/or post-consumer scrap, with internal scrap optionally also being used to manufacture the aluminium material.

12. Method according to claim 8,
wherein
a slug is first manufactured from the aluminium material, the slug is impact extruded into a cup-shaped, prismatic battery cell housing blank and the prismatic battery cell housing comprising a battery cell housing jacket and a battery cell housing base is finally formed from the cup-shaped battery cell housing blank by means of at least one further forming step, preferably by wall-ironing, wherein aluminium alloys of type AA1xxx, AA3xxx but also AA8xxx should preferably be used for the aluminium material.

13. Method according to claim 8,
wherein
an aluminium strip is manufactured from the aluminium material by rolling, from which aluminium strip a prismatic battery cell housing comprising a battery cell housing jacket and a battery cell housing base is manufactured by deep drawing and wall-ironing processes, wherein an aluminium alloy of type AA1xxx, AA3xxx, AA5xxx or AA8xxx is preferably used or alternatively a roll-formed battery cell housing jacket is formed from the aluminium strip by means of a roll-forming process, which aluminium strip has at least in areas a prismatic cross-section, the battery cell housing jacket is joined in the longitudinal direction, preferably in a positive-locking, frictional and/or material-bonded manner, the prismatic battery cell housing jacket is cut to length and is joined in a positive-locking, frictional and/or material-bonded manner with a battery cell housing bottom made from a sheet metal cut-out made from an aluminium strip made from the same or another aluminium material, wherein an aluminium alloy of type AA1xxx, AA3xxx, AA5xxx or AA8xxx is preferably used.

14. Method according to claim 8,
wherein
alternatively, a tube with a prismatic cross-section is extruded from the aluminium material for the battery cell housing jacket, which tube is optionally cut to length and is joined in a positive-locking, frictional and/or material-bonded manner after at least one optional processing step to provide the finally formed battery cell housing jacket with a battery cell housing base from a sheet metal cut-out made from an aluminium strip made from the same or another aluminium material, wherein an aluminium alloy of type AA1xxx, AA3xxx, AA6xxx or AA8xxx is preferably used.

15. Method according to claim 11,
wherein
the cup-shaped battery cell housings are closed with a battery cell housing lid made of a sheet metal cut-out made of an aluminium material during the cell assembly.

16. Use of an aluminium material for manufacturing a prismatic battery cell housing according to claim 1,
wherein
the aluminium material has a ratio of the amount of carbon dioxide emitted (CO2e) during the manufacture of the aluminium material in kg_{CO2e} per
kg_{Al material} to yield strength R_{p0.2} of the aluminium material in MPa of
₂ₑ/R_{p0.2}≤6.15% kg_{CO2e}/(MPa*kg_{Al material}),
₂ₑ/R_{p0.2}≤50% kg_{CO2e}/(MPa*kg_{Al material}),
₂ₑ/RR_{p0.2}≤4% kg_{CO2e}/(MPa*kg_{Al material}) or
₂ₑ/RR_{p0.2}≤2% kg_{CO2e}/(MPa*kg_{Al material}), wherein the yield strength R_{p0.2} is measured in accordance with DIN EN ISO 6892-1 at room temperature.

17. Use of an aluminium material for manufacturing a prismatic battery cell housing using a method according to claim 9,
wherein
the aluminium material has a ratio of the amount of carbon dioxide emitted (CO2e) during the manufacture of the aluminium material in kg_{CO2e} per
kg_{Al material} to yield strength R_{p0.2} of the aluminium material in MPa of
₂ₑ/R_{p0.2}≤6.15% kg_{CO2e}/(MPa*kg_{Al material}),
₂ₑ/R_{p0.2}≤50% kg_{CO2e}/(MPa*kg_{Al material}),
₂ₑ/R_{p0.2}≤4% kg_{CO2e}/(MPa*kg_{Al material}) or
₂ₑ/R_{p0.2}≤2% kg_{CO2e}/(MPa*kg_{Al material}), wherein the yield strength R_{p0.2} is measured in accordance with DIN EN ISO 6892-1 at room temperature.
